(19) United States
(12) Patent Application Publication
(10) Pub. No.: US 2015/0181288 A1
(43) Pub. Date: Jun. 25, 2015

(54) VIDEO SALES AND MARKETING SYSTEM

(71) Applicant: IGNITE VIDEO, INC., San Francisco, CA (US)

(72) Inventors: Paxton Song, Los Altos, CA (US); Ashanta S. Yapa, San Francisco, CA (US); Chang Zheng Li, San Francisco, CA (US)

(73) Assignee: IGNITE VIDEO, INC., San Francisco, CA (US)

(21) Appl. No.: 14/569,585

(22) Filed: Dec. 12, 2014

Related U.S. Application Data
(60) Provisional application No. 61/918,470, filed on Dec. 19, 2013.

(51) Int. Cl. H04N 21/442; H04N 21/258; H04N 21/25; H04N 21/254; H04N 21/81; H04N 21/222

(52) U.S. Cl. CPC H04N 21/44213; H04N 21/812; H04N 21/222; H04N 21/252; H04N 21/254; H04N 21/25891; H04N 21/44218; H04N 21/44222

(57) ABSTRACT

Disclosed herein are systems and methods for video advertising, sales and marketing including techniques for creating images and video, editing those images and videos, characterizing those images and videos and providing those images and videos to multiple users using social networks. Also include are methods for product placement and advertising associated with those videos including method for analyzing user interactions with the images and videos and optimizing ad placement in response to the user interactions.

### PRIORITY

This application claims the benefit of U.S. Provisional Patent application No. 61/918,470 entitled “video sales and marketing system” filed on Dec. 19, 2013 which is included by reference as if fully set forth herein.

### SUMMARY

Disclosed herein are systems and methods for video advertising, sales and marketing including techniques for creating images and video, editing those images and videos, characterizing those images and videos and providing those images and videos to multiple users using social networks. Also include are methods for product placement and advertising associated with those videos including method for analyzing user interactions with the images and videos and optimizing ad placement in response to the user interactions.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 shows a functional block diagram of a client server system 100 that may be employed for some embodiments according to the current disclosure.

FIG. 2 illustrates a flow chart of processes which may be included in some embodiments of a video sales and marketing system.

FIG. 3 illustrates an embodiment of a video player that may be employed according to certain aspects of the current disclosure.

FIG. 4 shows a system that may be used on some embodiments according to the current disclosure.

FIG. 5 depicts a process for optimizing video advertisement.

FIG. 6 shows a user input area of a software product employing certain of the methods described herein.

FIG. 7 illustrates a flowchart according to certain embodiments of the current disclosure.

### DESCRIPTION

Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

Lexicography

The term “declarative language” generally refers to a programming language that allows programming by defining the boundary conditions and constraints and letting the computer determine a solution that meets these requirements. Many languages applying this style attempt to minimize or eliminate side effects by describing what the program should accomplish, rather than describing how to go about accomplishing it. This is in contrast with imperative programming, which requires an explicitly provided algorithm.

The term “Meta tag” generally refers to special information providing information about an object. For example and without limitation a meta tag for a web page may provide short descriptions of the contents of the web page. Meta tags may facilitate searching web pages for specific content or search databases for specific items. As used herein, the term “keyword” is a form of meta tag.

The word “Middleware” generally means computer software that connects software components or applications. The software consists of a set of enabling services that allow multiple processes running on one or more machines to interact across a network. Middleware conventionally provides for interoperability in support of complex, distributed applications. It often includes web servers, application servers, and similar tools that support application development and delivery such as XML, SOAP, and service-oriented architecture.

The terms “raster graphics, “raster image”” and the like generally refer to a bitmap or dot matrix type structure representing a generally rectangular grid of pixels, or points of color, which may be visualized with a monitor, paper, or other display medium.

The term “structured data” generally includes a data store such as a database, XML file and the like.

The terms “vector image” or “vector graphics” generally refer to images which are constructed from geometrical primitives such as points, lines, curves, and shapes or polygon(s), which are all based on mathematical expressions. Vector graphics are based on vectors (also called paths, or strokes) which lead through locations called control points. Each of these points has a definite position on the x and y axes of a work space. Each point, as well, is a element of data structre, including the location of the point in the work space and the direction of the vector (which is what defines the direction of the track). Each track can be assigned a color, a shape, a thickness and often a fill.

The term “virtual machine” or “VM” generally refers to a self-contained operating environment that behaves as if it is a separate computer even though is is part of a separate computer or may be virtualized using resources form multiple computers.

The acronym “XML” generally refers to the Extensible Markup Language. It is a general-purpose specification for creating custom markup languages. It is classified as an extensible language because it allows its users to define their own elements. Its primary purpose is to help information systems share structured data, particularly via the Internet, and it is used both to encode documents and to serialize data.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

System Elements

Processing System

The methods and techniques described herein may be performed on a processor based device. The processor based device will generally comprise a processor attached to one or more memory devices or other tools for persisting data such as cloud or remote storage and the like. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touch screens, displays and terminals as well as remote connected computer systems, modems, radio transmitters and handheld personal communication devices such as cellular phones, “smart phones” and digital assistants.

The processing system may be a wireless devices such as a smart phone, personal digital assistant (PDA), laptop, notebook and tablet computing devices operating through wireless networks. These wireless devices may include a processor, memory coupled to the processor, cameras, displays, keypads, WiFi, Bluetooth, GPS and other I/O functionality.

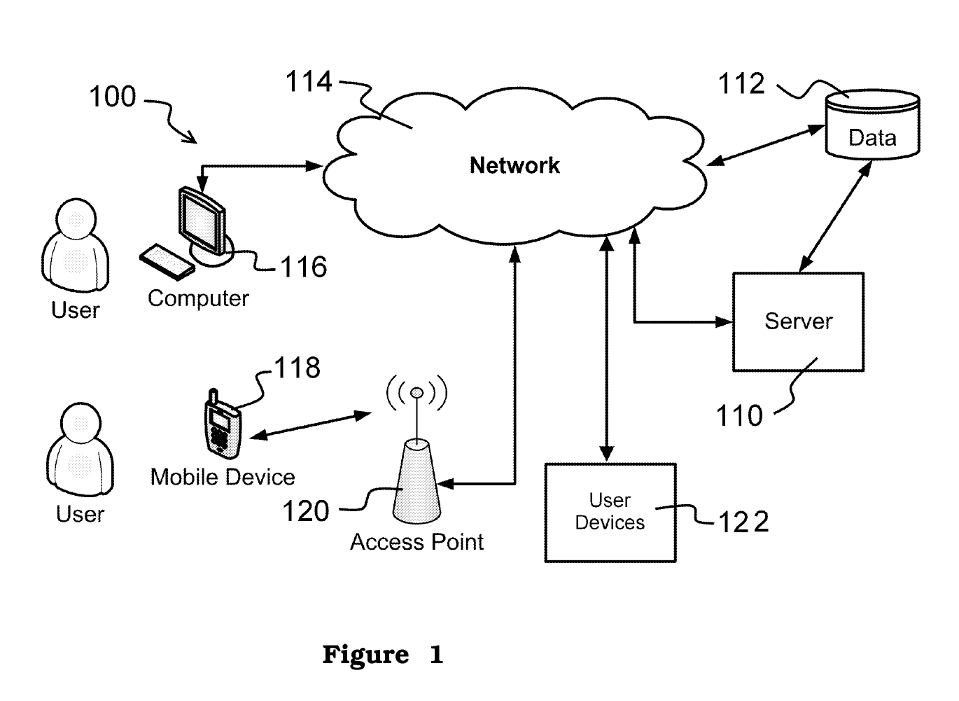

FIG. 1 shows a functional block diagram of a client server system 100 that may be employed for some embodiments according to the current disclosure. In the FIG. 1 a server 110 is coupled to one or more databases 112 and to a public network 114 such as the Internet. The network may include routers, hubs and other equipment to effectuate communications between all associated devices. A user accesses the server by a computer 116 communicably coupled to the network 114. The computer 116 may include a sound capture device such as a microphone (not shown). Alternatively the user may access the server 110 through the network 114 by using a smart device such as a telephone or PDA 118. The smart device 118 may connect to the server 110 through an access point 120 coupled to the network 114. The mobile device 118 may include both a sound capture device such as a microphone and one or more cameras.

Certain embodiments may employ both still and motion photography which may be effectuated using cameras on mobile electronic devices such as smartphones and tablet computers as well as convention devices such as HD and stereo cameras which may be coupled to fixed or portable devices.

Client Server Processing

Conventionally, client server processing operates by dividing the processing between two devices such as a server and a smart device such as a cell phone or other computing device. The workload is divided between the servers and the clients according to a predetermined specification. For example in a “light client” application, the server does most of the data processing and the client does a minimal amount of processing, often merely displaying the result of processing performed on a server.

In accordance with the current disclosure, displaying includes showing information to a user, formatting information for a user to display on a local device, transmitting information in a format that can be displayed on a remote device and the like. One having skill in the art will recognize that formatting information into graphics files, PDF files, HTML documents and the like, for transmission to a remote device for display constitutes displaying the information.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine readable instructions are conventionally known including applets and are written in a variety of languages including Java and JavaScript.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing. One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, a user interface and the like may be employed. These engines may seek and gather information about events from remote data sources.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

Video Content Creation

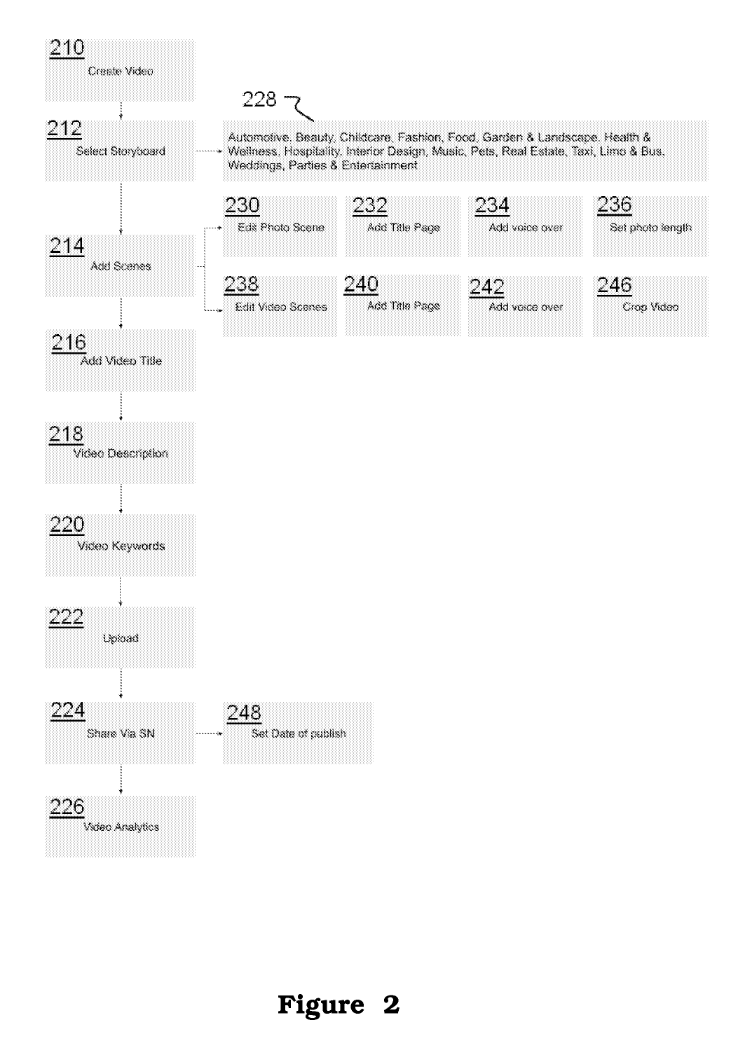

FIG. 2 illustrates a flow chart of processes which may be included in some embodiments of a video sales and marketing system. In FIG. 2 the method begins at a flow label 210 for creation of a video. The video may be created on any one of the many commercial video capture tools that are conventionally available. The video may include at least one image representing a product or service. For example and without limitation, the video may show an image of a shoe. The video may have imagery of the shoe from multiple perspectives and show the shoe on a person's foot, on a display case or any combinations of settings where the user desires to depict the shoe. While the inventors contemplate using raw video, there is nothing in this disclosure to limit the images to video. For example and without limitation still photography or animations may be employed in some embodiments.

At a step 212 a user selects a storyboard. The storyboard provides for different environments where the imagery of the video may me presented. In some embodiments the storyboard may be a collection of scenes that may be associated with the product or service depict in the video. The storyboards may be stored as structured data and made available to a user through a selection protocol. In some embodiments a user may upload one or more images to create their own storyboard. In certain embodiments the storyboards may include guidance for creating the video (infra).

At a step 214 a user adds scenes to the video. Adding scenes 214 may include a series of steps such as editing the photo scene at a step 230, adding a title page at a step 232, adding voice over or music at a step 234 and cropping or adjusting photo length at steps 246 and 236 respectively. In some embodiments scenes are meta-images attached to the video such that they appear to be part of the original video or meta data to facilitate ordering a product. This may include hyperlinks to a webpage for seeing more product details or for ordering the product. This may be effectuated using layering techniques thus allowing for easy extraction of a desired object from the resulting structured data. Additional meta-data may include hyperlinks to a webpage for seeing more product details, more video, music, sound tracks, or information for ordering the product. A representative example of a data structure for use in providing portions of the methods described herein is included in the attached appendix.

At a step 216 a title for the video is added and at a step 218 a description for the video is added.

At a step 220 keywords are added. Keywords may include product characteristics such as color, material, manufacturer, size, product category and the like. In certain embodiments keywords may include marketing information, suggested uses for a product or service, ordering information, viewing tracking information and the like. In some embodiments, key words might be suggested in response to information about the video. For example and without limitation if object recognition identifies one or more objects in the video, those keywords can be suggested to a user or automatically included.

In steps 222 and 224 the video is uploaded to a network server and information about the video is shared via social network sites such as Facebook, Twitter and the like. In some embodiments a publishing date may be established at a step 248. This provides for preparation of one or more videos in advance, say while executing a complex promotional campaign, and having the videos all become publicly available at the same time or in response to a triggering event.

At a step 226 video analytics may be performed. Analytic information may include but is not limited to video impressions, click-through information, clicks on scroll buttons, number of loops for looping video, time viewing and voice or digital conversation information related to the video.

Video Player

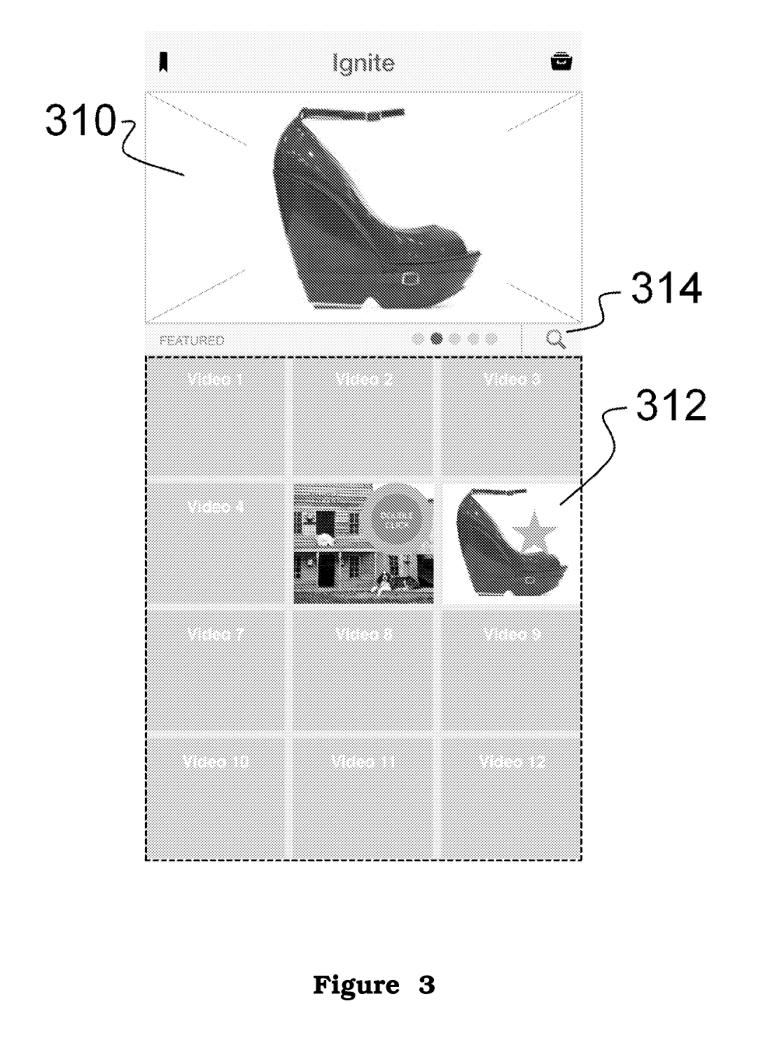

FIG. 3 illustrates an embodiment of a video player that may be employed according to certain aspects of the current disclosure. The video player may include a display area 310 for depicting one or more videos. The videos may be selection from a selection area 312 such that clicking, tapping or other indication will present the desired video into the display area 310. Controls for the video are included.

In operation the videos may be organized by category. For example and without limitation, these categories may include price, product, service or application among others. A user may search for a category visually by selecting a representative image for the category, or enter a category name using a search tool 314. Once the user selects a category, the video panels will populate with other videos from that category. A user may then scroll through and select a video of interest.

A user may place an image of a selected item into a new scene, in effect, creating a reverse green screen. To effectuate a reverse green screen, a user may capture an image using a camera on a smartphone, select an object from the video player, and superimpose the object onto the captured image. Sizing and other controls may be employed to properly position the object onto the image. The image may be placed using differing opacity such that all or part of a background image may be visible. Once positioned, a user may create a new video for transmission to another person, ordering, or posting online via an Internet site.

Object Recognition

Certain embodiments according to the current disclosure may employ various forms of object recognition and tracking. Object recognition may be effectuated from rasterized or vector shapes. Rasterized or vector shapes may be created from an image by having a user select all (or a portion) of a particular shape and rendering the shape into as the desired format. Structural analysis and shape descriptors may be calculated from routines to determine the moments of an image and the mass center of an image.

Once structural analysis and moments are computed, an image may be repositioned by repositioning a key point and redrawing the image. Similarly, an image may be identified in an object by tracking the movement of a key point or by identifying structure and moments and comparing the data to pre-existing data. Accordingly, a data source containing information about the structure of an object may be queried to identify an object in a video or still image by calculating the object's structure and searching a data store for like objects. In other embodiments edge orientation histograms may be employed. A histogram of oriented gradient descriptors describes a shape within an image by the distribution of intensity gradients or edge directions. The implementation of these descriptors may be achieved by dividing the image into small connected regions, called cells, and for each cell compiling a histogram of gradient directions or edge orientations for the pixels within the cell. The combination of these histograms then represents the descriptor. In some embodiments the local histograms can be contrast-normalized by calculating a measure of the intensity across a larger region of the image, called a block, and then using this value to normalize all cells within the block, in effect mitigating in part variances from changes in illumination or shadows.

One having skill in the art will appreciate that original video capture using green screens and other masking techniques may provide for easier integration when combining videos to make more detailed presentations. In certain embodiments a video green screen may be effectuated using portable cameras, smart-phones and the like. In operation, a user may frame an image in a camera's viewfinder, identify the desired object in the image using screen icons such as translucent boxes, capture the image or video and remove background detail from the image before saving it. Background removal may be effectuated using conventional techniques such as chroma-key replacement or background subtraction.

In other embodiments software may be employed to characterize the object of the video green screen. For example and without limitation, once an image of the object is captured, relative geometry values may be calculated as well as indications of color, and texture. Conventionally color histograms, color tuples and filtering are employed to characterize and image. This data may be calculated and stored as meta-data along with the image. Moreover, one having skill in the art will recognize that conventional image editing techniques will provide for editing the image by varying these characteristics such that the color or texture of an image may be modified for use in other photographs and motion video.

In some embodiments items in a video may be identified using a boundary box. The boundary box may be identified at an early or first frame of a video by selecting one or more edges of the image of the desired item. The boundary box process may use edge detection or feature point detection to identify all visible edges or features of the item. Once identified, similar detection may be applied to each subsequent frame of a video. If the object or a feature point are detected in the first frame or its subsequent frame tracking an object edge or feature point for each subsequent frame may be effected using conventional algorithms. A calculation engine may be used to perform transformations of each object edge or feature point detected in the first frame or subsequent frames to calculate edges or features as the camera angle for the desired object changes.

By way of illustration and without limitation, if a boundary box is created about an object in a first frame of video, as the frames of the video move, object detection will identify the trajectory of the object through the relative eye of the camera. Once identified, the object may be abstracted into a new video without the background images. Moreover, edge or feature detection may provide for identification of 3D objects as the trajectory of the edge of feature moves within the video frame. An edge or feature moving off camera may allow for detection of related edges or features entering the frame at the same or similar trajectory. If a full 360 degree video of an object is captured, the final frame will include the edge or feature of the initial frame allowing extraction from the video of the item's characteristics. This allows for placement of all or part of the identified object into another image or video scene.

Object recognition and tracking allows for finding a particular object or inserting a particular object into any image or video. The view of the object may track the background image by presenting the object in 3 dimensions. Accordingly, certain embodiments may allow for creating a collection of objects which may be represented in 3 dimensions. These objects may be categorized and made searchable.

Once objects in a video are recognized, identification information, such as description, price and ordering information may be presented to a user. Optional variations for the object may also be presented. For example and without limitation, if a user selects or captures video of a bedroom, then selects a portion of the video showing a chair, image analysis can identify characteristics about that chair and search a database to find like or similar chairs. Then the user may be presented with ordering information, similar or complementary products, and the like. In certain embodiments a sales transaction may be effectuated using the camera image by relating an image or portion of an image to an object or to a sales transaction server.

In some embodiments a user may capture an image using a camera on a mobile device, perform object recognition on a portion of the image. The object recognition may be performed at the camera level or image information may be transmitted to a server for recognition. The server may then present to the user a like or similar object which the user may then select. Once selected, an image or video of the like or similar object may be pasted into the image allowing a user to see how the object would look and providing tools for purchasing the object. For example and without limitation, if a user were to photograph a bedroom, then select a portion of a lamp in the bedroom, the server may, in response to that selecting, provide the user with optional lamps for placement in the image of the bedroom. The user may then purchase the light through the interface on the mobile device.

In certain embodiments a user may capture an image, select an object and transfer the object into a new scene or image, thus allowing a user to visual how the object would appear in a new location. Moreover, with object recognition and video, the object may be characterized and rendered in 3 dimensions in the new location. Accordingly, a video of a new lamp may be imposed on a video of a bedroom, allowing a user to experience the new lamp in the bedroom, created a video showing multiple views of the lamp, and share that video through social networking or other networked resources.

System Operation

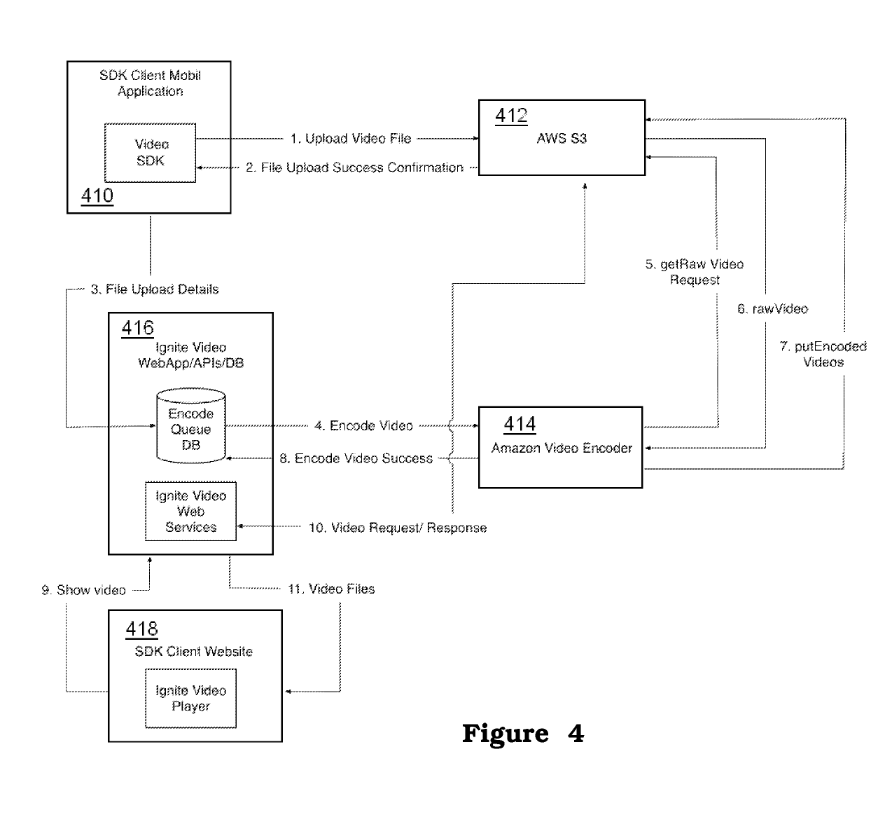

FIG. 4 shows a system that may be used on some embodiments according to the current disclosure. A mobile device may be running a client mobile application 410 developed using a software development kit (SDK). The SDK contains code for implementing certain features in accordance with this disclosure. Included in the SDK is a Video SDK for capturing, editing, creating scenes and the like. One having skill in the art will appreciate that the SDKs may operate on the client mobile device or using client-server techniques to shift processing to other devices such as server and cloud computing devices.

When a video is created it may be uploaded to a web service 412 for storage such as Amazon Web Services S3 (the upload channel) for storage and transport to different processes. In addition file upload details may be transmitted for storage at a server 416. The server 416 may provide a web interface (or web application) providing features similar to the mobile client along with more advanced features which the hardware of a mobile device may not be able to perform. In addition the server 416 may provide an application programming interface (API) for clients to access web services on the server 416. The server 416 may also provide for encoding and decoding functionality. This may be effectuated on the server or remotely through the use of conventional encoders such as Amazon's Video encoder 414 and the like. Once encoded, videos may be stored on cloud storage devices such as a web service 412.

A client website 418 may be coupled to the server 416 for providing an online video player. A website SDK may provide developers with functionality for accessing the server 416 for the servicing, display and interoperability of certain methods described herein.

Advertisement Optimization Engine

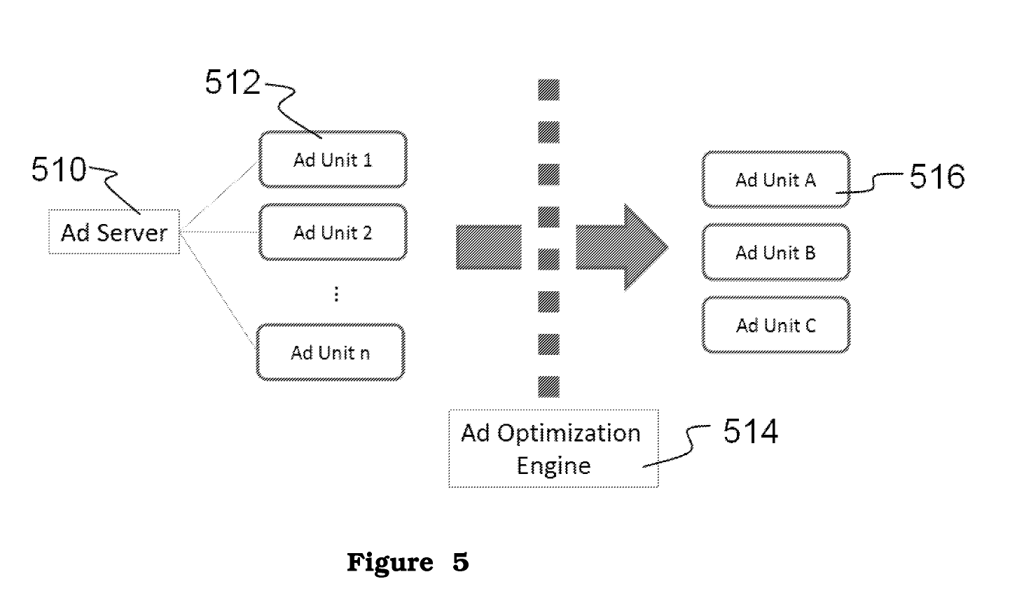

FIG. 5 depicts a process for optimizing video advertisement. An ad server 510 may create video or flash based video advertisings units (Ad Units) 512 based upon the video files which are provided by the upload channel (product feed) The ad units 512 may be correlated with the product feed using meta tags, object recognition or other relational techniques for determining an ad content to video relationship. In some embodiments there may be multiple ad units per video.

An Ad Optimization Engine 514 may quantify ad information such as impressions, click-throughs, dwell time, user interactions, sales results, loops, online conversations and the like for particular videos or portions thereof. Optimization would occur after observing results from an initial assortment of ad units. New Ad units may be created based on the initial quantification. For example and without limitation, a portion of an ad unit may generate more interest than another portion of the same ad unit. Therefore a new ad unit may be created using just the high interest portion. The quantification will allow for optimizing ad unit placement and sales performance by showing the ad units 512 which have the best performance more frequently than lower performing ad units.

In some embodiments the duration of the advertising video loops may correlate to the price point of the items. Therefore, a $5 product may have a shorter video ad loop whereas a $600 item may have a video ad loop duration considerably longer. Higher involvement sales may be optimized using longer ad units. Ad timing may also be viewer demographic dependant and certain embodiments may provide for differing lengths of ads at different times of day, different seasons or in response to different social events. For example and without limitation ads for certain impulse products may be shorter and more frequent late in the evening than during the day.

The Ad Server 510 may also provide for one or more:

RTB (Real Time Bidding) integration for product sales;

Multiple Ad Exchange/Network integration for operating with other ad servers and networks;

Global Impression capping to control overall flow of ads across multiple networks;

Aged user capping to provide for stopping ad placements under certain conditions such as a predetermined stop date.

In some embodiments ad service may include creation of a product file. The product file may include one or more of the following:

Product ID

SKU

Name & Description of the product

Manufacturer's suggested retail price

Image URLS

Video URLS

The product file relates a product or service to one or more units. In some embodiments a user creates a video showing the product in use in one or more scenes which may be subsequently shown to a perspective customer (a prospect). While viewing the video, identifying information may be stored on a local computer relating the customer to the product or service.

Ad units may be extracted from the user created video such that the ad units comprise shorter video snippets such 3, 5 or 7 second clips showing the key portions of the product or service. The snippets may be related to the image detection methods described herein such that appropriate video content may be provided for the ad units. Moreover, each ad unit may include details about the scene or angle of the product in addition to the product information described above.

In operation when a user views a web page or other online content, the ad units may be displayed as part of an online promotional effort. The ad units may serve as “reminder ads” to effectuate top-of-mind awareness of the product or service being promoted by the advertising campaign. For example and without limitation, if a prospect views an ad, subsequent ads may be short in duration, yet still keep the product or service fresh in the mind of the prospect.

In addition, when a prospect changes to different online content the ad units may detect the different content and display a video ad unit more related to the online content. For example and without limitation, if a car is being promoted and a user is viewing a news related web page, the ad unit may display the car in a financial district or surrounded by offices. If the user changes to a sporting related web page, the ad unit may show the same car, but on a race track or other sports related venue. Categorization of the product and venue allows for better optimization protocols. One having skill in the art will appreciate that video creation, combined with the scenes and storyboards described herein provide for changing of product placement into new environments.

Storyboard Operation

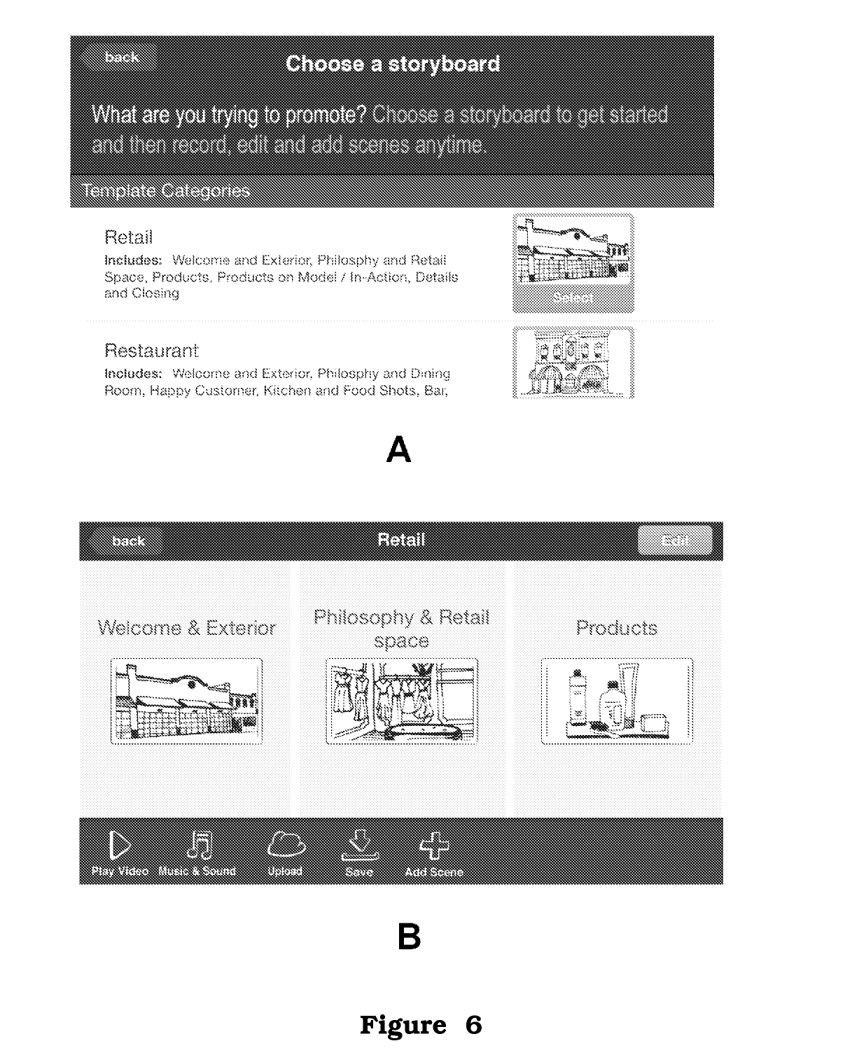

FIG. 6 shows a user input area of a software product employing certain of the methods described herein. In FIG. 6A a user is presented with a menu of templates of storyboards for creating videos. The initial menu guides the user to the type of product or service they want to promote. For example and without limitation, retail products or restaurants (as shown) may be selected. Once a user selects a template they are directed to an additional, more specific, menu as shown in FIG. 6B.

FIG. 6B presents the user with a more detailed selection of templates. For example the exterior retail space or products of a retail store (as shown). Once a user selects the desired template, menus will walk the user through the creation of a preferred video for the template. For example if a user selects a template of the exterior of a retail environment, on-screen guidance is provided in the form of translucent directions superimposed on a camera view screen to guide the user to capturing the ideal images. In a retail environment this may include guiding the user through different scenes of the front of the store and the scenes of entering the store.

In some embodiments a smartphone, tablet computer, or digital camera includes software for operation of the templates as described herein. In operation a user selects a template from the installed application then selects a template. The application then opens the camera view and provides guidance for the appropriate videos for capture. In some embodiments the guidance includes translucent instructions overlaid on a camera viewer which may be incorporated into the application. These overlays may include text, icons and imagery to provide instruction to the camera user. Step-by-step guidance helps the camera operator collect all of the video that may be desired to promote a product or service.

The template may also request information about the video from the user. This information may include a description, keywords, product information and the like for use in generating advertising. In some embodiments keywords may be suggested for the user to employ and the suggestions may be in response to the object recognition methods described herein. For example and without limitation if an object recognition algorithm identifies a product such as a chair, keywords used to characterize other chairs may be selected and included in the information. The information may then be stored in a structured data source and related to the video.

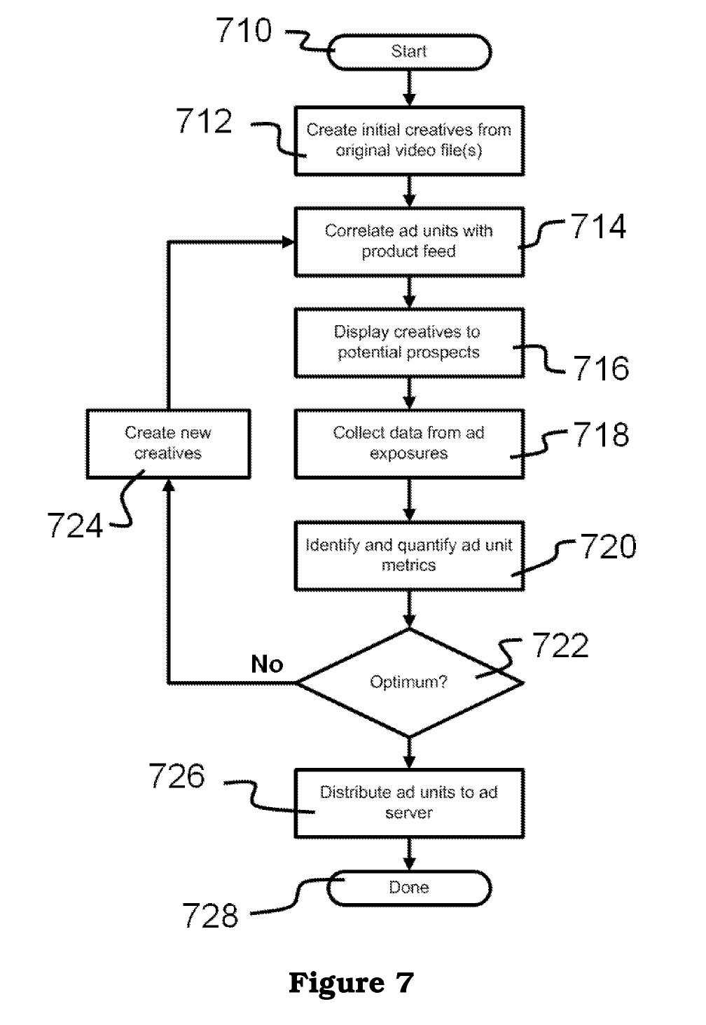

FIG. 7 illustrates a flowchart according to certain embodiments of the current disclosure. The method starts at a flow label 710. At a step 712 initial creatives (ad units) are derived from an original video. The video may describe a product or service and include video information such as video content and meta-data associated with the video.

At a step 714 the ad units are correlated with a product feed. The ad units may be correlated with the product feed using meta tags, object recognition or other relational techniques for determining an ad content to video relationship.

At a step 716 the initial ad units are displayed to prospects and at a step 718 responses from those prospects are collected as metrics for analysis.

At a step 720 the ad units metrics are analyzed.

At a step 722 the metric are tested against prior metrics to determine if the response rate has been achieved or if the response rate has been maximized.

If the response rate is achieved, flow passes to a step 726 where the optimized ad units are distributed to ad servers to be used as part of an advertising campaign.

If the response rate is not optimum, than flow passes to a step 724 where new ad units are created. The new ad units may be a portion of the original ad unit, which might be selected from the response of initial viewers. For example and without limitation, if viewers respond to an ad unit at a certain point in time, the new creative may only include video from around that point in time.

Once new ad units are created, flow move to the step 724 and a portion of the process is repeated until the ad unit is optimized.

At a flow label 728 the method ends.

The above illustration provides many different embodiments or embodiments for implementing different features of the invention. Specific embodiments of components and processes are described to help clarify the invention. These are, of course, merely embodiments and are not intended to limit the invention in any way.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed:

1. A method including:
receiving, over a network, video information, said video information including meta information associated with a product or service;
displaying that video information to one or more users;
determining user interest in the video information;
altering the video information in response to the user interest, wherein said altering includes removing portions of video that have low user interest.

2. The method of claim 1 wherein the user interest includes a measure of at least one of click-through information, dwell time information, user interaction information, sales results, or online conversations.

3. The method of claim 1 further including:
distributing the video information to an ad server.

4. A method including:
receiving, at a server, a first ad unit, said ad unit including at least first video information;
exposing the first ad unit to a plurality of prospects;
receiving, from the prospects, user interest information, said interest information associated with the first ad unit;
effectuating a second ad unit in response to the interest information, said effectuating including modifying the first ad unit by altering the length of the first video.

5. The method of claim 4 further including:
exposing the second ad unit to a plurality of prospects;
receiving, from the prospects, user interest information, said interest information associated with the second ad unit.

6. The method of claim 4 wherein the user interest information includes at least one of click-through information, dwell time information, user interaction information, sales results, or online conversations.

7. The method of claim 6 further including:
measuring user the interest information, and
associating that measuring with a portion of the first video information, wherein the second ad unit length is effectuating in response to the measuring.

8. The method of claim 4 further including:
distributing the second ad unit to an ad server.

9. One or more processor readable storage devices having processor readable, non-transitory, code embodied on said processor readable storage devices, said processor readable code for programming one or more processors to perform a method comprising:
receiving a first ad unit, said ad unit including at least first video information;
exposing the first ad unit to a plurality of prospects;
receiving, from the prospects, user interest information, said interest information associated with the first ad unit;
effectuating a second ad unit in response to the interest information, said effectuating including modifying the first ad unit by altering the length of the first video.

10. The device of claim 9 wherein the method further includes:
exposing the second ad unit to a plurality of prospects;
receiving, from the prospects, user interest information, said interest information associated with the second ad unit.

11. The device of claim 9 wherein the user interest information includes at least one of click-through information, dwell time information, user interaction information, sales results, or online conversations.

12. The device of claim 11 wherein the method further includes:
measuring user the interest information, and
associating that measuring with a portion of the first video information, wherein the second ad unit length is effectuating in response to the measuring.

13. The device of claim 9 wherein the method further includes:
distributing the second ad unit to an ad server.
